(19) United States
(12) Patent Application Publication
(10) Pub. No.: US 2018/0060436 A1
(43) Pub. Date: Mar. 1, 2018

(54) SYSTEM AND METHOD FOR CACHING CONCEPT STRUCTURES IN AUTONOMOUS VEHICLES

(71) Applicant: Cortica, Ltd., Tel Aviv (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/677,496

(22) Filed: Aug. 15, 2017

Related U.S. Application Data
(63) Continuation-in-part of application No. 15/162,042, filed on May 23, 2016.
Application No. 15/162,042 is a continuation of application No. 14/013,636, filed on Aug. 29, 2013, now Pat. No. 9,372,940.
Application No. 14/013,636 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009, now Pat. No. 9,798,795.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009, now Pat. No. 9,798,795.
(60) Provisional application No. 62/375,453, filed on Aug. 16, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04L 29/08; H04L 29/12; G06Q 30/02

(52) U.S. Cl. CPC G06F 17/30864; H04L 67/02; H04L 61/2007; G06Q 30/0241; G06F 17/30979; G06F 17/30598; G06F 17/3002

(57) ABSTRACT

A method and system for caching concept structures in a cache memory of a vehicle control system of an autonomous vehicle. The method includes collecting driving data generated by at least one sensor of the autonomous vehicle, wherein the driving data includes at least a location pointer of the autonomous vehicle; retrieving at least one concept structure that matches the collected at least one location pointer, wherein each retrieved concept structure includes metadata describing a concept of a driving decision; and storing the retrieved at least one concept structure in the cache memory.

### CROSS-REFERENCE TO RELATED APPLICATIONS

This application claims the benefit of U.S. Provisional Patent Application No. 62/375,453 filed on Aug. 16, 2016. This application is also a continuation-in-part (CIP) of U.S. patent application Ser. No. 15/162,042 filed on May 23, 2016, now pending, which is a continuation of U.S. patent application Ser. No. 14/013,636 filed on Aug. 29, 2013, now U.S. Pat. No. 9,372,940. The Ser. No. 14/013,636 application is a CIP of U.S. patent application Ser. No. 13/602,858 filed on Sep. 4, 2012, now U.S. Pat. No. 8,868,619, which is a continuation of U.S. patent application Ser. No. 12/603,123 filed on Oct. 21, 2009, now U.S. Pat. No. 8,266,185. The Ser. No. 12/603,123 application is a continuation-in-part of:
(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;
(2) U.S. patent application Ser. No. 12/195,863 filed on Aug. 21, 2008, now U.S. Pat. No. 8,326,775, which claims priority under 35 USC 119 from Israeli Application No. 185414 filed on Aug. 21, 2007, and which is also a continuation-in-part of the above-referenced U.S. patent application Ser. No. 12/084,150;
(3) U.S. patent application Ser. No. 12/348,888 filed on Jan. 5, 2009, now allowed, which is a CIP of the above-referenced U.S. patent application Ser. No. 12/084,150 and the above-referenced U.S. patent application Ser. No. 12/195,863; and
(4) U.S. patent application Ser. No. 12/538,495 filed on Aug. 10, 2009, now U.S. Pat. No. 8,312,031, which is a CIP of the above-referenced U.S. patent application Ser. No. 12/084,150; the above-referenced U.S. patent application Ser. No. 12/195,863; and the above-referenced U.S. patent application Ser. No. 12/348,888.
All of the applications referenced above are herein incorporated by reference.

### TECHNICAL FIELD

The present disclosure relates generally to the analysis of multimedia content, and more specifically to a system for caching concept structures in a cache memory of a vehicle control system.

### BACKGROUND

In part due to improvements in computer processing power and in location-based tracking systems such as global positioning systems, automated and other assisted driving systems have been developed with the aim of providing driverless control or driver-assisted control of vehicles during transportation. An autonomous vehicle includes a system for controlling the vehicle based on the surrounding environment such that the vehicle autonomously controls functions such as accelerating, braking, steering, and the like.

The autonomous driving vehicle may maintain a distance from an obstacle existing on a path and adjust a speed and a travelling direction according to a shape of a road to find a destination independently without operation of a steering wheel, an acceleration pedal, or a brake by a driver in the vehicle. For example, the autonomous driving vehicle may accelerate while on a straight road, and decelerate while changing a travelling direction in accordance with a curvature of a curved road.

Existing solutions for automated driving may use a global positioning system receiver, electronic maps, and the like, to determine a path from one location to another. Fatalities and injuries due to vehicles colliding with people or obstacles during the determined path are significant concerns for developers of autonomous driving systems. To this end, automated driving systems may utilize sensors such as cameras and radar for detecting objects to be avoided. However, not all vehicles in the near future will be autonomous, and even among autonomous vehicles, additional safety precautions are warranted. Further, some existing automated solutions face challenges in avoiding dangerous circumstances, particularly when the presence or absence of obstacles and other events requiring altering driving varies between trips.

Therefore, it would be advantageous to provide a solution that can generate real-time driving decisions based on analysis of similar cases and implement such driving decisions in an autonomous driving control system.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for caching concept structures in a cache memory of a vehicle control system of an autonomous vehicle. The method comprises: collecting driving data generated by at least one sensor of the autonomous vehicle, wherein the driving data includes at least a location pointer of the autonomous vehicle; retrieving at least one concept structure that matches the collected at least one location pointer, wherein each retrieved concept structure includes metadata describing a concept of a driving decision; and storing the retrieved at least one concept structure in the cache memory.

Certain embodiments disclosed herein also include a non-transitory computer readable medium having stored thereon causing a processing circuitry to execute a process for caching concept structures in a cache memory of a vehicle control system of an autonomous vehicle, the process comprising: collecting driving data generated by at least one sensor of the autonomous vehicle, wherein the driving data includes at least a location pointer of the autonomous vehicle; retrieving at least one concept structure that matches the collected at least one location pointer, wherein each retrieved concept structure includes metadata describing a concept of a driving decision; and storing the retrieved at least one concept structure in the cache memory.

Certain embodiments disclosed herein also include a system for caching concept structures in a cache memory of a vehicle control system of an autonomous vehicle. The system comprises: a processing circuitry; and a memory, the memory containing instructions that, when executed by the processing circuitry, configure the system to: collect driving data generated by at least one sensor of the autonomous vehicle, wherein the driving data includes at least a location pointer of the autonomous vehicle; retrieve at least one concept structure that matches the collected at least one location pointer, wherein each retrieved concept structure includes metadata describing a concept of a driving decision; and store the retrieved at least one concept structure in the cache memory.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram of a deep-content classification (DCC) system for creating concept structures.

FIG. 2 is a flowchart illustrating the operation of the patch attention processor of the DCC system.

FIG. 3 is a block diagram depicting the basic flow of information in a large-scale video matching system.

FIG. 4 is a diagram showing the flow of patches generation, response vector generation, and signature generation in a large-scale speech-to-text system.

FIG. 5 is a flowchart illustrating the operation of the clustering processor of the DCC system.

FIG. 6 is a flowchart illustrating the operation of the concept generator of the DCC system.

FIG. 7 is a network diagram utilized to describe the various disclosed embodiments.

FIG. 8 is a flowchart illustrating a method for caching concept structures according to an embodiment.

FIG. 9 is a flowchart illustrating a method for determining driving decisions based on cached concept structures according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

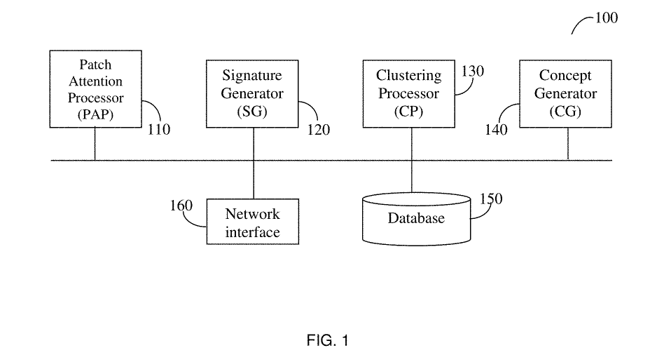

FIG. 1 shows an example diagram of a deep-content classification (DCC) system 100 for creating concept structures. The example DCC system 100 includes a patch attention processor (PAP) 110, a signature generator (SG) 120, a clustering processor (CP) 130, a concept generator (CG) 140, a database (DB) 150, and a network interface 160.

The DCC system 100 is configured to receive multimedia data elements (MMDEs), for example from the Internet via the network interface 160. The MMDEs may include, but are not limited to, images, graphics, video streams, video clips, audio streams, audio clips, video frames, photographs, images of signals, combinations thereof, and portions thereof. The images of signals are images of, for example, medical signals, geophysical signals, subsonic signals, supersonic signals, electromagnetic signals, and infrared signals.

The MMDEs may be stored in or kept in the DB 150 for future retrieval of the respective MMDE based on a reference to the MMDE. Such a reference may be, but is not limited to, a universal resource locator (URL). Every MMDE in the DB 150, or referenced therefrom, is then processed by the PAP 110, resulting in a plurality of patches that are of specific interest, or otherwise of higher interest than other patches. A more general pattern extraction, such as an attention processor (AP) may also be used in lieu of patches. The AP receives the MMDE that is partitioned into items; an item may be an extracted pattern or a patch, or any other applicable partition depending on the type of the MMDE. The functions of the PAP 110 are described herein below in more detail.

Those patches that are of higher interest are then used by the SG 120 to generate signatures based on the patch. The operation of the SG 120 is described in more detail herein below. The CP 130 initiates a process of inter-matching of the signatures once it determines that there are a number of patches that are above a predefined threshold. The threshold may be defined to be large enough to enable proper and meaningful clustering. With a plurality of clusters, a process of clustering reduction takes place so as to extract the most useful data about the cluster and keep it at an optimal size to produce meaningful results. The process of cluster reduction is continuous. When new signatures are provided after the initial phase of the operation of the CP 130, the new signatures may be immediately checked against the reduced clusters to save on the operation of the CP 130. A more detailed description of the operation of the CP 130 is provided herein below.

The CG 140 operates to create concept structures from the reduced clusters provided by the CP 130. Each concept structure includes a plurality of metadata associated with the reduced clusters. The result is a compact representation of a concept that can now be easily compared against a MMDE to determine if the received MMDE matches a concept structure stored, for example, in the DB 150 by the CG 140. This can be done, for example and without limitation, by providing a query to the DCC system 100 for finding a match between a concept structure and a MMDE. A more detailed description of the operation of the CG 140 is provided herein below.

It should be appreciated that the DCC system 100 can generate a number of concept structures that is significantly smaller than the number of MMDEs. For example, if one billion (10⁹) MMDEs need to be checked for a match against another one billion MMDEs, typically the result is that no less than 10⁹×10⁹=10¹⁸ matches have to take place, a daunting undertaking. The DCC system 100 would typically have around 10 million concept structures or less, and therefore at most only 2×10⁶×10⁹=2×10¹⁵ comparisons need to take place, a mere 0.2% of the number of matches that have had to be made by other solutions. As the number of concept structures grows significantly slower than the number of MMDEs, the advantages of the DCC system 100 would be apparent to one with ordinary skill in the art.

The operation of the PAP 110 will now be provided in greater detail with respect to an image as the MMDE. However, this should not be understood as to limit the scope of the invention; other types of MMDEs are specifically included herein and may be handled by the PAP 110.

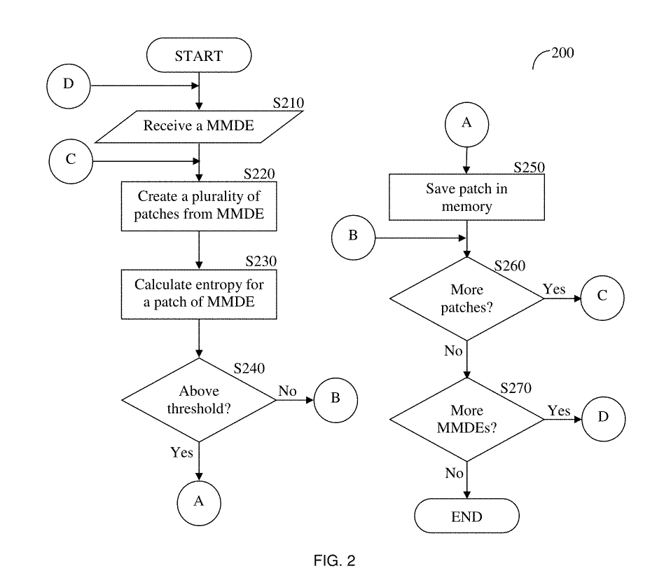

FIG. 2 depicts an exemplary and non-limiting flowchart 200 of the operation of the PAP 110. In S210 the PAP 110 receives a MMDE from a source for such MMDEs. Such a source may be a system that feeds the DCC system 100 with MMDEs or other sources for MMDEs, for example the world-wide-web (WWW). In S220 the PAP 110 creates a plurality of patches from the MMDE. A patch of an image is defined by, for example, its size, scale, location and orientation. A patch may be, for example and without limitation, a portion of an image of a size 20 pixels by 20 pixels of an image that is 1,000 pixels by 500 pixels. In the case of audio, a patch may be a segment of audio 0.5 seconds in length from a 5-minute audio clip. In S230 a patch not previously checked is processed by the PAP 110 to determine its entropy. The entropy is a measure of the amount of interesting information that may be present in the patch. For example, a continuous color of the patch has little interest while sharp edges, corners or borders, will result in higher entropy representing a lot of interesting information. The plurality of statistically independent cores, the operation of which is discussed in more detailed herein below, is used to determine the level-of-interest of the image and a process of voting takes place to determine whether the patch is of interest or not.

In S240, it is checked whether the entropy was determined to be above a predefined threshold, and if so execution continues with S250; otherwise, execution continues with S260. In S250 the patch having entropy above the threshold is stored for future use by the SG 120 in, for example, DB 150. The preconfigured threshold level may be configured based on, for example, the sensitivity of the detection. For example, a lower threshold value may be set for a security application than would be set for an entertainment application. In S260 it is checked whether there are more patches of the MMDE to be checked, and if so execution continues with S220; otherwise execution continues with S270. In S270 it is checked whether there are additional MMDEs, and if so execution continues with S210; otherwise, execution terminates. It would be appreciated by those of skill in the art that this process reduces the information that must be handled by the DCC system 100 by focusing on areas of interest in the MMDEs rather than areas that are less meaningful for the formation of a concept structure.

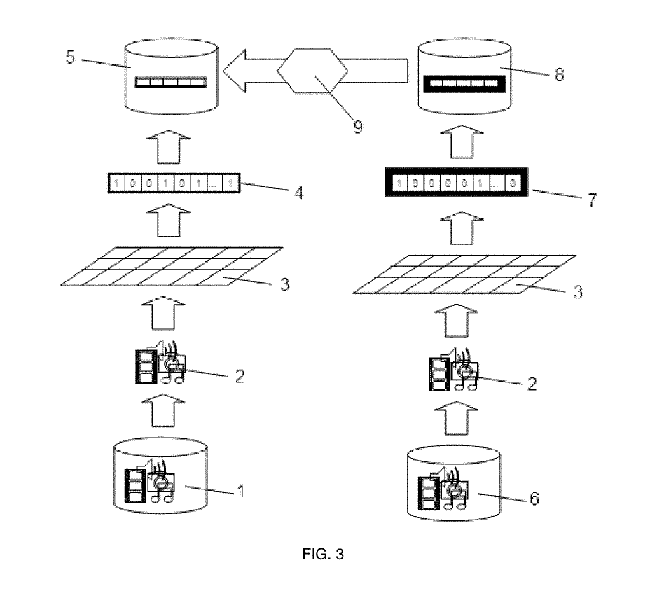

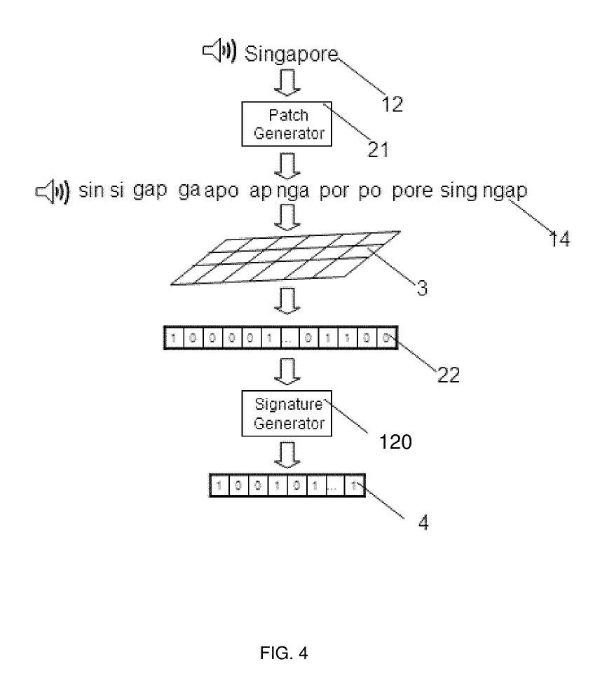

A high-level description of the process for large scale video matching performed by the Matching System is depicted in FIG. 3. Video content segments 2 from a Master DB 6 and a Target DB 1 are processed in parallel by a large number of independent computational cores 3 that constitute the architecture. Further details on the computational cores generation are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Referring back to FIG. 3, at the final step, Target Robust Signatures and/or Signatures database 4 are effectively matched, by a matching algorithm 9, to Master Robust Signatures and/or Signatures database 7 to find all matches between the two databases.

A brief description of the operation of the SG 120 is therefore provided, this time with respect to a MMDE which is a sound clip. However, this should not be understood as to limit the scope of the invention and other types of MMDEs are specifically included herein and may be handled by SG 120. To demonstrate an example of signature generation process, it is assumed, merely for the sake of simplicity and without limitation on the generality of the disclosed embodiments, that the signatures are based on a single frame, leading to certain simplification of the computational core's generation. The Matching System shown in FIG. 3 is extensible for signatures generation capturing the dynamics in-between the frames and the information of the frame's patches.

The signatures generation process will be described with reference to FIG. 4. The first step in the process of signatures generation from a given speech-segment is to break-down the speech-segment to K patches 14 of random length P and random position within the speech segment 12. The break-down is performed by the patch generator component 21. The value of K is determined based on optimization, considering the tradeoff between accuracy rate and the number of fast matches required in the flow process of the Matching System. In the next step, all the K patches are injected in parallel to all L computational Cores 3 to generate K response vectors 22. The vectors 22 are fed into the SG 120 to produce a Signatures and Robust Signatures 4.

In order to generate Robust Signatures, i.e., Signatures that are robust to additive noise L (where L is an integer equal to or greater than 1) computational cores are utilized in the Matching System. A frame i is injected into all the Cores. The computational cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$$ni = θ ( Vi - {Th}_{x} ) ;$$

where θ is a Heaviside step function; wᵢⱼ is a coupling node unit (CNU) between node i and image component j (for example, grayscale value of a certain pixel j); kⱼ is an image component j (for example, grayscale value of a certain pixel j); Thₓ is a constant Threshold value, where x is ‘S’ for Signature and ‘RS’ for Robust Signature; and Vᵢ is a Coupling Node Value.

The Threshold values Thₓ are set differently for Signature generation and for Robust Signature generation. For example, for a certain distribution of Vᵢ values (for the set of nodes), the thresholds for Signature (Th_{S}) and Robust Signature (Th_{RS}) are set apart, after optimization, according to at least one or more of the following criteria:

I:For: Vᵢ>Th_{RS}

1−p(V>Th_{S})−1−(1−ε)^{l}<<1

i.e., given that I nodes (cores) constitute a Robust Signature of a certain image I, the probability that not all of these I nodes will belong to the Signature of same, but noisy image, Ĩ is sufficiently low (according to a system's specified accuracy).

II:p(Vᵢ>Th_{RS})≈l/L

i.e., approximately I out of the total L nodes can be found to generate Robust Signature according to the above definition.

III: Both Robust Signature and Signature are generated for certain frame i.

It should be understood that the creation of a signature is a unidirectional compression where the characteristics of the compressed data are maintained but the compressed data cannot be reconstructed. Therefore, a signature can be used for the purpose of comparison to another signature without the need of comparison of the original data. The detailed description of the Signature generation can be found in U.S. Pat. Nos. 8,326,775 and 8,312,031, assigned to the common assignee, which are hereby incorporated by reference.

Computational core generation is a process of definition, selection, and tuning of the architecture parameters for a certain realization in a specific system and application. The process is based on several design considerations, such as: (a) The cores should be designed so as to obtain maximal independence, i.e. the projection from a signal space should generate a maximal pair-wise distance between any two cores' projections into a high-dimensional space; (b) The cores should be optimally designed for the type of signals, i.e. the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power, and, (c) The cores should be optimally designed with regard to invariance to a set of signal distortions, of interest in relevant applications. Detailed description of the computational core generation, the computational architecture, and the process for configuring such cores is discussed in more detail in the issued U.S. Pat. No. 8,655,801 referenced above.

Hence, signatures are generated by the SG 120 responsive to patches either from the PAP 110 or retrieved from the DB 150, as discussed hereinabove. It should be noted that other ways for generating signatures may also be used for the purpose the DCC system 100. Furthermore, as noted above, the array of computational cores may be used by the PAP 110 for the purpose of determining if a patch has an entropy level that is of interest for signature generation according to the principles of the invention. The generated signatures are stored, for example, in the DB 150, with reference to the MMDE and the patch for which it was generated, thereby enabling back annotation as may be necessary.

Portions of the CP 130 have been discussed in detail in the U.S. Pat. No. 8,386,400, assigned to the common assignee (hereinafter the “'400 patent”), and which is hereby incorporated for all that it contains. In accordance with an embodiment, an inter-match process and clustering thereof is utilized. The process can be performed on signatures provided by the SG 120. It should be noted though that this inter-matching and clustering process is merely an example for the operation of the CP 130 and that other inter-matching and/or clustering processes may be used for the purpose of the invention.

Following is a brief description of the inter-match and clustering process. The unsupervised clustering process maps a certain content-universe onto a hierarchical structure of clusters. The content-elements of the content-universe are mapped to signatures, when applicable. The signatures of all the content-elements are matched to each other, and consequently generate the inter-match matrix. The described clustering process leads to a set of clusters. Each cluster is represented by a small/compressed number of signatures, for example signatures generated by the SG 120 as further explained hereinabove, which can be increased by variants. This results in a highly compressed representation of the content-universe. A connection graph between the multimedia data elements of a cluster may be stored. The graph can then be used to assist a user searching for data to move along the graph in the search of a desired multimedia data element.

In another embodiment, upon determination of a cluster, a signature for the whole cluster may be generated based on the signatures of the multimedia data elements that belong to the cluster. It should be appreciated that using a Bloom filter may be used to reach such signatures. Furthermore, as the signatures are correlated to some extent, the hash functions of the Bloom filter may be replaced by simpler pattern detectors, with the Bloom filter being the upper limit.

While signatures are used here as the basic data elements, it should be realized that other data elements may be clustered using the techniques discussed above. For example, a system generating data items is used, where the data items generated may be clustered according to the disclosed principles. Such data items may be, without limitation, multimedia data elements. The clustering process may be performed by dedicated hardware or by using a computing device having storage to store the data items generated by the system and then performing the process described herein above. Then, the clusters can be stored in memory for use as may be deemed necessary.

The CP 130 further uses an engine designed to reduce the number of signatures used in a structure, in a sense extracting only the most meaningful signatures that identify the cluster uniquely. This can be done by testing a removal of a signature from a cluster and checking if the MMDEs associated with the cluster still are capable of being recognized by the cluster through signature matching.

The process of signature extraction is on-going as the DCC system 100 operates. It should be noted that after initialization, upon signature generation by the SG 120 of a MMDE, its respective signature is first checked against the clusters to see if there is a match and if so it may not be necessary to add the signature to the cluster or clusters but rather simply associate the MMDE with the identified cluster or clusters. However, in some cases where additional refinement of the concept structure is possible, the signature may be added, or at times even replace one or more of the existing signatures in the reduced cluster. If no match is found, then the process of inter-matching and clustering may take place.

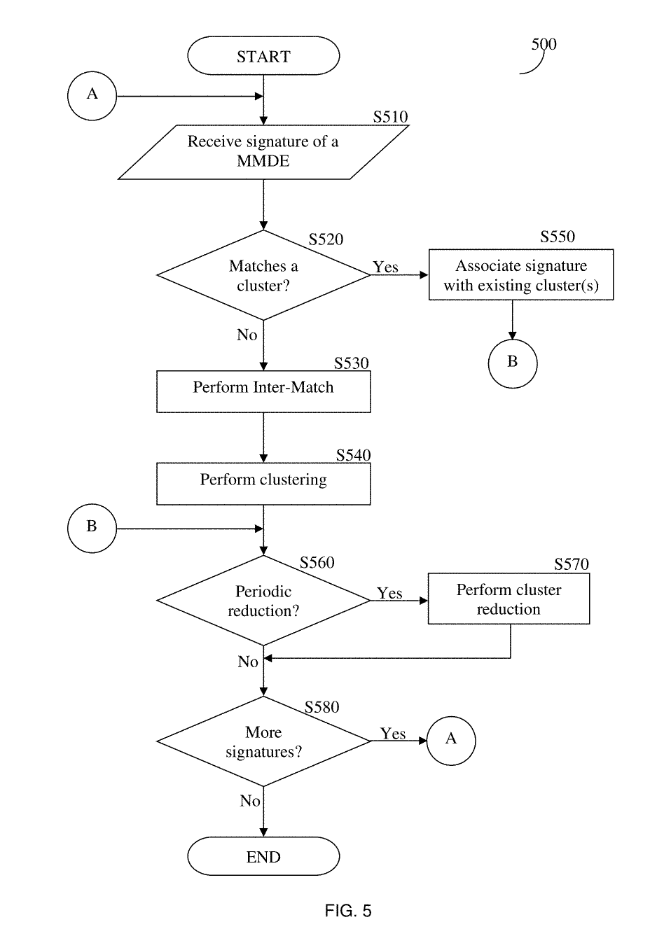

FIG. 5 depicts an example flowchart 500 illustrating the operation of the CP 130. In S510 a signature of a MMDE is received, for example from the SG 120. In S520 it is checked whether the signature matches one or more existing clusters and if so execution continues with S550; otherwise, execution continues with S530. In S530 an inter-match between a plurality of signatures previously received by the DCC system 100 is performed, for example in accordance with the principles of the '400 patent. As may be necessary, the DB 150 may be used to store results or intermediate results as the case may be, however, other memory elements may be used. In S540 a clustering process takes place, for example in accordance with the principles of the '400 patent. As may be necessary the DB 150 may be used to store results or intermediate results as the case may be, however, other memory elements may be used.

In S550, the signature identified to match one or more clusters is associated with the existing cluster(s). In S560 it is checked whether a periodic cluster reduction is to be performed, and if so execution continues with S570; otherwise, execution continues with S580. In S570 the cluster reduction process is performed. Specifically, the purpose of the operation is to ensure that in the cluster there remains the minimal number of signatures that still identify all of the MMDEs that are associated with the signature reduced cluster (SRC). This can be performed, for example, by attempting to match the signatures of each of the MMDEs associated with the SRC having one or more signatures removed therefrom. The process of cluster reduction for the purpose of generating SRCs may be performed in parallel and independently of the process described herein above. In such a case, after either S560 or S570, the operation of S580 takes place. In S580 it is checked whether there are additional signatures to be processed and if so execution continues with S510; otherwise, execution terminates. SRCs may be stored in memory, such as DB 150, for the purpose of being used by other elements comprising the DCC system 100.

The CG 140 performs two tasks, it associates metadata to the SRCs provided by the CP 130 and it associates between similar clusters based on commonality of metadata. Example methods for associating metadata with MMDEs is described in the above-referenced U.S. patent application Ser. No. 12/348,888, entitled “Methods for Identifying Relevant Metadata for Multimedia Data of a Large-Scale Matching System”, filed on Jan. 5, 2009, assigned to the common assignee (hereinafter the “'888 application”), which is hereby incorporated by reference. One embodiment of the '888 application includes a method for identifying and associating metadata to input MMDEs. The method comprises comparing an input first MMDE to at least a second MMDE; collecting metadata of at least the second MMDE when a match is found between the first MMDE and at least the second MMDE; associating at least a subset of the collected metadata to the first MMDE; and storing the first MMDE and the associated metadata in a storage.

Another embodiment of the '888 application includes a system for collecting metadata for a first MMDE. The system comprises a plurality of computational cores enabled to receive the first MMDE, each core having properties to be statistically independent of each other core, each generating responsive to the first MMDE a first signature element and a second signature element, the first signature element being a robust signature; a storage unit for storing at least a second MMDE, metadata associated with the second MMDE, and at least one of a first signature and a second signature associated with the second MMDE, the first signature being a robust signature; and a comparison unit for comparing signatures of MMDEs coupled to the plurality of computational cores and further coupled to the storage unit for the purpose of determining matches between multimedia data elements; wherein responsive to receiving the first MMDE the plurality of computational cores generate a respective first signature of said first MMDE and/or a second signature of said first MMDE, for the purpose of determining a match with at least a second MMDE stored in the storage and associating metadata associated with the at least second MMDE with the first MMDE.

Similar processes to match metadata with a MMDE or signatures thereof may be used. Accordingly, each SRC is associated with metadata which is the combination of the metadata associated with each of the signatures that are included in the respective SRC, preferably without repetition of metadata. A plurality of SRCs having metadata may now be associated to each other based on the metadata and/or partial match of signatures. For example and without limitation, if the metadata of a first SRC and the metadata of a second SRC overlap more than a predetermined threshold level, for example 50% of the metadata match, they may be considered associated clusters that form a concept structure. Similarly, a second threshold level can be used to determine if there is an association between two SRCs where at least a number of signatures above the second threshold are identified as a match with another SRC. The preconfigured threshold level may be configured based on, for example, the sensitivity of the detection. For example, a lower threshold value may be set for a security application than would be set for an entertainment application. As a practical example, one may want to consider the concept of Abraham Lincoln, where images of the late President and features thereof, appear in a large variety of photographs, drawings, paintings, sculptures and more and are associated as a concept structure of the concept “Abraham Lincoln”. Each concept structure may be then stored in memory, for example the DB 150, for further use.

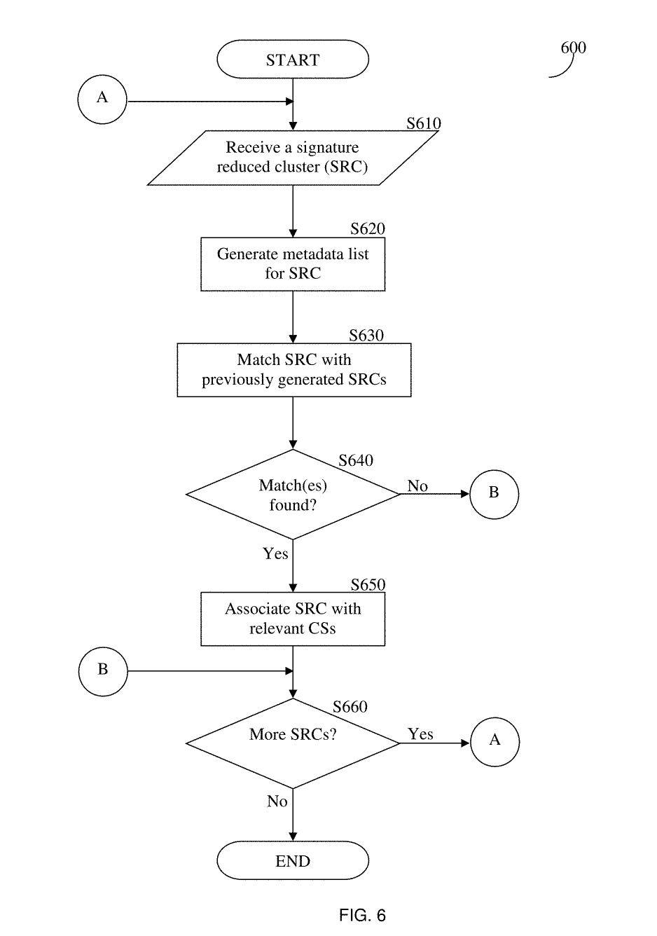

FIG. 6 shows an example flowchart 600 illustrating the operation of the CG 140. In S610 the CG 140 receives a SRC from either the CP 130 or by accessing a memory such as, for example, the DB 150. In S620 metadata are generated for the signatures of the SRC, for example in accordance with the principles described hereinabove. A list of the metadata is created for the SRC preferably with no metadata duplication. In one embodiment, the commonality of metadata is used to signify the strength of the metadata with respect to a signature and/or the SRC, i.e., a higher number of metadata repetitions is of more importance to the SRC than a lower number of repetitions. Furthermore, in one embodiment, a threshold may be used to remove those metadata that have a significantly low rate of repetition as not being representative of the SRC. The threshold can be preconfigured based on, for example, the sensitivity of the detection. For example, a lower threshold value may be set for a security application than would be set for an entertainment application.

In S630 the SRC is matched to previously generated SRCs to attempt to find various matches, as described, for example, hereinabove in more detail. In S640, it is checked if at least one match was found and if so, execution continues with S650; otherwise, execution continues with S660. In S650 the SRC is associated with one or more of the concept structures to which the SRC has been shown to match. In S660 it is checked whether additional SRCs are to be received and if so execution continues with S610; otherwise, execution terminates.

A person skilled in the art would now appreciate the advantages of the DCC system 100 and the methods thereof. The DCC system 100 is configured to create, automatically and in an unsupervised fashion, concept structures of a wide variety of MMDEs. When checking a new MMDE it may be checked against the concept structures stored, for example, in the DB 150, and upon detection of a match providing the concept information about the MMDE. With the number of concept structures being significantly lower than the number of MMDEs the solution is cost effective and scalable for the purpose of identification of content of a MMDE.

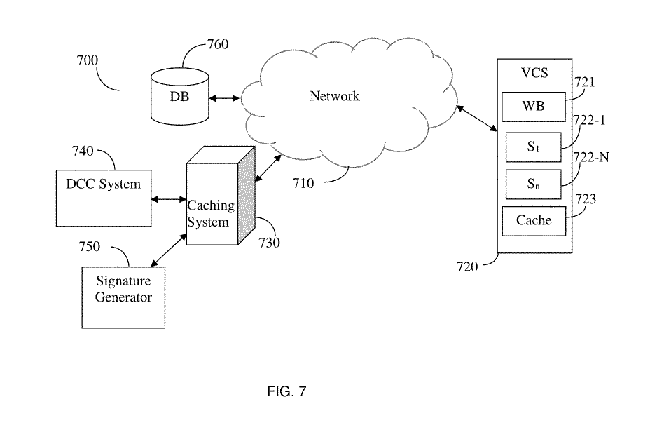

FIG. 7 shows an example network diagram 700 utilized to describe various disclosed embodiments. A vehicle control system (VCS) 720, a caching system 730, a deep-content classification (DCC) system 740, a signature generator 750, and a database 760, are communicatively connected via the network 710. The network 710 may be the Internet, the world-wide-web (WWW), a local area network (LAN), a wide area network (WAN), a metro area network (MAN), and the like.

The VCS 720 is configured to control driving of an autonomous vehicle (not shown). To this end, the VCS 720 may be installed in or communicatively connected to one or more components of the autonomous vehicle. The autonomous vehicle may be, for example, an unmanned ground vehicle (UGV), an unmanned aerial vehicle (UAV), a remotely operated underwater vehicle, and the like. The autonomous vehicle may operate without an onboard human presence. Autonomous vehicles can be used for many applications where it may be inconvenient, dangerous, or impossible to have a human operator present.

In an embodiment, the VCS is configured to provide at least partially autonomous control of a vehicle. The VCS 720 includes at least a program to access the World Wide Web (WWW) such as, but not limited to, a web browser 721. The VCS 720 also includes one or more sensors 722-1 through 722-n (collectively referred hereinafter as sensors 722 or individually as a sensor 722, merely for simplicity purposes). Each of the sensors 722 is configured to capture sensory signals from an environment around the autonomous vehicle, and may be installed in, on, or in proximity to, the autonomous vehicle.

In an embodiment, the sensory signals are captured with respect to a MMDE displayed over the web browser 721. The sensors 722 may include, but are not limited to, a microphone, a camera (e.g., a web camera) a Global Positioning System (GPS), an image analyzer, a speech recognizer, and the like. The sensors 722 are configured to generate metadata related to sensor signals captured by the VCS 720. Such metadata may be, for example, environmental variables related to the captured signals. Such variables may include, but are not limited to, time of capture, location (e.g., geographic location), motion information (e.g., based on accelerometer data, gyroscope data, etc.), weather information within the location, and more.

In an embodiment, the caching system 730 configured to at least fetch concept structures from the database 760 based on the collected metadata. To this end, the caching system 730 is connected to the DCC system 740, the signature generator 750, or both (as shown). The DCC system 740 is configured and operates as the DCC system 100 discussed in detail above. The signature generator 750 is configured and operates as the SG 120. In some implementations, the SG 120 of the DCC system 100 is utilized as the signature generator 750.

In an embodiment, the caching system 730 is configured to collect driving data related to the sensor signals captured by the VCS 720. The driving data may include, but is not limited to, the sensor signals, metadata of the sensor signals, or both. In an example implementation, the metadata includes at least a location pointer indicating a location of the VCS 720, and may further include time pointers indicating, for example, times of capture of the sensor signals. As an example, the metadata may include GPS coordinates of the VCS 720. Using the collected driving data, one or more concept structures is fetched by the caching system 730 from the DDC system 740. The fetched concept structures are sent to the VCS 720 and stored in a cache memory 723 of the VCS 720.

Specifically, in an embodiment, the driving data may be sent to the DCC system 740, the signature generator 750, or both. Signatures are generated (e.g., by the signature generator 720 or a signature generator of the DCC system 740) based on the sent driving data. Based on the generated signatures, the DCC system 740 is configured to determine one or more matching concept structures for the driving data. The determination may include matching the generated signatures to signatures representing concept structures stored in the DCC system 740. The matching concept structures may be sent to the caching system 730. In an example implementation, the generated signatures may match a concept structure when the generated signatures and signatures representing the concept structure match above a predetermined threshold.

The concept structures stored in the DCC system 740 may include concept structures representing driving decisions to be determined with respect to parameters utilized for making autonomous driving decisions. Such parameters may include, but are not limited to, time, geographic location, street, county, city, state, country, direction of driving (e.g., North, South, East, West, etc.), presence or absence of obstacles (e.g., other cars, pedestrians, etc.), and the like. For example, the driving decisions may include, but are not limited to, not making a turn on a street, not parking on a street during street cleaning times, stopping at a particular geographic location, navigating around an obstacle, and the like.

As a non-limiting example, based on driving data collected by the VCS 720, signatures are generated. The driving data include a GPS location on 42^{nd} Street, New York, N.Y., and a time of 10:10 AM. The generated signatures are matched to signatures of concept structures stored in the DCC system 740, and the DCC system 740 determines a matching concept structure representing the concept of “do not park on 42^{nd} Street in Midtown Manhattan, N.Y. from 10-11 AM.”

In an embodiment, the VCS 720 is configured to retrieve the concept structures matching the signatures of the driving data. To this end, the VCS 720 sends the collected driving data to the DCC system 740 to retrieve matching concept structures. The matching can be performed based on the metadata associated with a concept structure, signatures of the concept structure, or both. The matching concept structures are cached in the cache 723.

Caching the concept structures allows for more efficient subsequent retrieval of the concept structures. Such efficient retrieval may be needed during autonomous driving, as autonomous driving decisions often must be made quickly in real-time and use of network connections increases computing resources and time needed for making driving decisions. The caching may be particularly useful when an autonomous vehicle regularly returns to the same location, for example when the location includes a street frequently used by the autonomous vehicle.

During autonomous driving by the VCS 720, a matching concept structure can be determined based on concept structures cached in the VCS 720. As an example, an input multimedia content element is a picture captured by the sensor 722-3 of the VCS 720. In this embodiment, signatures are generated for the input multimedia content element locally by the VCS 720. The generated signatures are compared to signatures of each concept structure cached in the VCS 720. A process for identifying a matching concept structure based on signatures is discussed herein above. A matching cached concept structure is determined and utilized to determine a driving decision. For example, the driving decision may be determined based on metadata of the matching concept structure or based on one or more MMDEs associated with the matching concept structure.

It should be noted that the DCC system 740 and the signature generator 750 are shown in FIG. 7 as being directly connected to the caching system 730 merely as an example. The DCC system 740, the signature generator 750, or both may be connected to the caching system 730 through the network 710, or may be embedded in the caching system 730, without departing from the scope of the disclosure.

It should also be noted that the caching system 730 typically includes a processing circuitry and a memory (not shown). The processing circuitry may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory may be volatile (e.g., RAM, etc.), non-volatile (e.g., ROM, flash memory, etc.), or a combination thereof. In one configuration, computer readable instructions to implement one or more embodiments disclosed herein may be stored in the storage.

In another embodiment, the memory is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry, cause the processing circuitry to perform the various processes described herein.

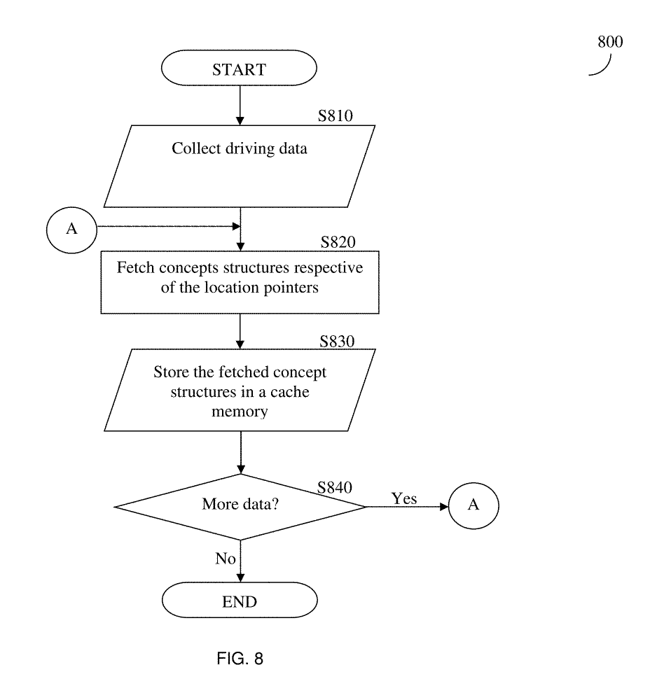

FIG. 8 is an example flowchart 800 illustrating a method for fetching concept structures based on input driving data according to an embodiment. In an embodiment, the method is performed by the VCS 720.

At S810, driving data is collected. The driving data may be collected from sensors deployed in or on a vehicle and may include, but is not limited to, sensor signals, metadata associated with sensor signals, or both. In an example implementation, the driving data includes one or more location pointers showing a current location of the vehicle during a trip (i.e., a driving session).

At S820, one or more matching concept structures is fetched based on the collected driving data. In an embodiment, S820 includes sending the collected driving data to a signature generator system, a DCC system, or both. Signatures are generated by the signature generator system or the DCC system. Based on the generated signatures, the DCC system is configured to determine one or more matching concept structures stored therein. In another embodiment, the driving data is sent to a remote server that is configured to fetch the matching concept structures based on the driving data.

In some implementations, S820 may include generating signatures for the driving data. The signatures may be generated via multiple at least partially statistically independent computational cores, the properties of each core being set independently of the properties of each other core. The resulting signatures may be robust to noise and distortions, and allow for more accurate identification of concepts represented in multimedia content.

Each concept structure is a collection of signatures and metadata describing the concept represented by the concept structure. The signatures may be generated using statistically independent computational cores as described herein. The concept structures stored in the DCC system may include concept structures indicating driving decisions with respect to sets of one or more driving parameters such that a matching concept structure indicates a driving decision that should be implemented by an autonomous vehicle given the current circumstances demonstrated by the sensor signals and metadata. For example, a concept structure stored in the DCC system may include metadata such as “make a right turn when traveling on 1^{st} Street to arrive at Main Street.”

Utilizing signatures to determine matching concept structures and, consequently, driving decisions, allows for more accurate determination of appropriate driving decisions, as the signatures allow for accurate identification of content of MMDEs.

At S830, the fetched concept structures are stored in a cache memory for subsequent use. The cache memory may be a cache memory of a vehicle control system configured for at least partially autonomous driving. Thus, the cached concept structures may be utilized to determine autonomous driving decisions in real-time based on multimedia content collected by the vehicle control system during driving.

At S840, it is checked whether additional driving data has been collected and, if so, execution continues with S820; otherwise, execution terminates.

As a non-limiting example, as an autonomous vehicle is driving east on 37th street in New York City, GPS signals are collected as driving data. The GPS signals indicate locations and directions of movement of the autonomous vehicle. Signatures are generated for the GPS signals and matched to signatures of concept structures for known driving decisions. A concept structure having metadata indicating “do not make a left turn while driving east on 37th street” is determined as matching and cached.

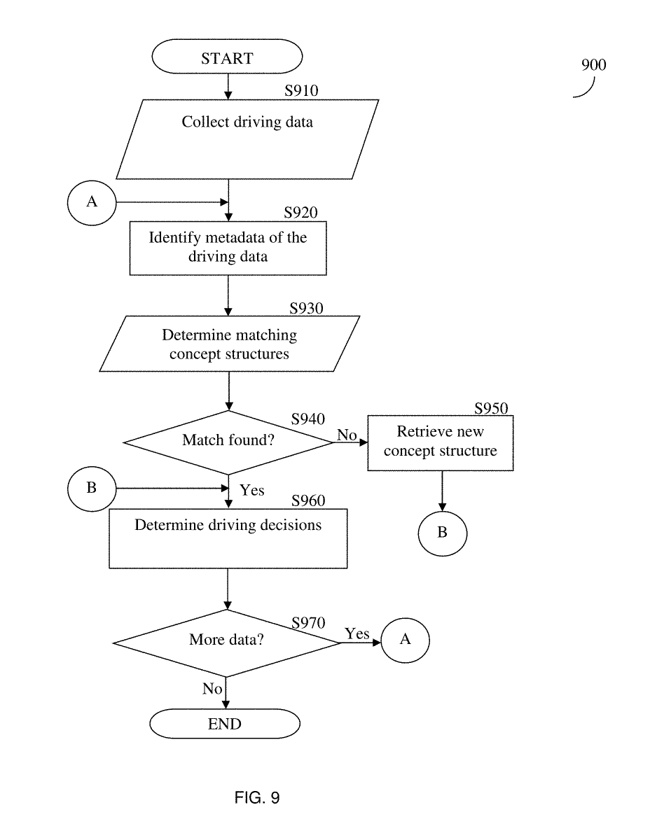

FIG. 9 is an example flowchart 900 illustrating a method for determining driving decisions for an autonomous vehicle based on cached concept structures according to an embodiment. In an example implementation, the method is performed by the VCS 720 based on concept structures cached in the cache 723. The VCS 720 is configured to control driving of the autonomous vehicle. The cached concept structures may be cached as described herein above with respect to FIG. 8.

At S910, driving data is collected. The driving data may be collected from sensors deployed in or on the autonomous vehicle. The driving data includes at least metadata. The metadata may indicate, for example, location pointers, time pointers, and the like.

At S920, metadata of the driving data is identified. The metadata may be utilized to determine concept structures of appropriate driving decisions.

At S930, the identified metadata is compared to metadata of concept structures cached in the cache 723. As noted above, each cached concept structure is a collection of signatures and metadata describing a concept of a driving decision with respect to parameters utilized for determining driving decisions. Accordingly, matching metadata of the driving data to metadata of that of a cached concept structure allows for determining an appropriate driving decision given the current circumstances of the vehicle.

At S940, it is checked if matching concept structures have been found and, if so, execution continues with S960; otherwise, execution continues with S950.

At S950, if no matching concept structure was found, a new concept structure is retrieved based on the driving data. In an embodiment, S950 may include sending the driving data to a signature generator system, a DCC system, or both. Signatures are generated for the driving data and utilized by the DCC system to determine a matching concept structure. The matching concept structure is retrieved and may be cached in the cache 723.

At S960, when one or more matching concept structures is found, one or more driving decisions is determined based on the matching concept structures. Specifically, the driving decisions may be determined based on the metadata of the matching concept structures. In some implementations, the driving decisions may be determined based further on independently determined driving decisions such as, for example, driving decisions that are part of a predetermined route determined prior to or during a trip. For example, based on a predetermined route including making a turn onto West Main Street and a matching concept structure indicating that no turns onto West Main Street can be made at the current location, a driving decision to proceed straight and make the next turn onto a street in the West direction.

At S970, it is checked whether additional driving data has been received and, if so, execution continues with S920, otherwise, execution terminates. In an embodiment, the received additional driving data may be checked repeatedly at predetermined time intervals for updated driving decisions. Repeatedly checking newly received driving data against cached concept structures allows for updating driving decisions in real-time based on metadata of newly received sensor signals.

It should be noted that various embodiments described herein are discussed with respect to autonomous vehicles without limitation on the disclosed embodiments. Automated driving decisions for any vehicle using at least partially automated driving, including autonomous vehicles, assisted driving vehicles (e.g., vehicles configured for automated braking while a human operator drives), vehicles with automated parking systems, and the like, may be equally utilized without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for caching concept structures in a cache memory of a vehicle control system of an autonomous vehicle, comprising:
collecting driving data generated by at least one sensor of the autonomous vehicle, wherein the driving data includes at least a location pointer of the autonomous vehicle;
retrieving at least one concept structure that matches the collected at least one location pointer, wherein each retrieved concept structure includes metadata describing a concept of a driving decision; and
storing the retrieved at least one concept structure in the cache memory.

2. The method of claim 1, wherein vehicle control system is configured to determine automated driving decisions for the autonomous vehicle based on the cached at least one concept structure.

3. The method of claim 2, wherein the vehicle control system is configured to determine the automated driving decisions based further on the metadata of the cached at least one concept structure and metadata of at least one multimedia content element captured by sensors of the autonomous vehicle.

4. The method of claim 1, wherein the matching at least one concept structure is retrieved from a deep content classification (DCC) system, the DCC system storing a plurality of concept structures, each concept structure further including a collection of signatures generated based on multimedia data elements.

5. The method of claim 4, wherein the matching at least one concept structure is retrieved from the DCC system based on at least one signature generated for the driving data and the collections of signatures of the plurality of concept structures stored in the DCC system.

6. The method of claim 5, further comprising:
sending, to a signature generator system, at least a portion of the driving data, wherein the signature generator system is configured to generate the at least one signature for the driving data based on the sent at least a portion of the driving data.

7. The method of claim 6, wherein the signature generator system includes a plurality of at least statistically independent computational cores, wherein the properties of each core are set independently of the properties of each other core.

8. The method of claim 5, wherein the DCC system is configured to compare the at least one signature generated for the driving data to the collection of signatures of each concept structure, wherein the collection of signatures of each matching concept structure matches the at least one signature generated for the driving data above a predetermined threshold.

9. A non-transitory computer readable medium having stored thereon instructions for causing a processing circuitry to execute a process for caching concept structures in a cache memory of a vehicle control system of an autonomous vehicle, the process comprising:
collecting driving data generated by at least one sensor of the autonomous vehicle, wherein the driving data includes at least a location pointer of the autonomous vehicle;
retrieving at least one concept structure that matches the collected at least one location pointer, wherein each retrieved concept structure includes metadata describing a concept of a driving decision; and
storing the retrieved at least one concept structure in the cache memory.

10. A system for caching concept structures in a cache memory of a vehicle control system of an autonomous vehicle, comprising:
a processing circuitry; and
a memory connected to the processing circuitry, the memory containing instructions that, when executed by the processing circuitry, configure the system to:
collect driving data generated by at least one sensor of the autonomous vehicle, wherein the driving data includes at least a location pointer of the autonomous vehicle;
retrieve at least one concept structure that matches the collected at least one location pointer, wherein each retrieved concept structure includes metadata describing a concept of a driving decision; and
store the retrieved at least one concept structure in the cache memory.

11. The system of claim 10, wherein vehicle control system is configured to determine automated driving decisions for the autonomous vehicle based on the cached at least one concept structure.

12. The system of claim 11, wherein the vehicle control system is configured to determine the automated driving decisions based further on the metadata of the cached at least one concept structure and metadata of at least one multimedia content element captured by sensors of the autonomous vehicle.

13. The system of claim 10, wherein the matching at least one concept structure is retrieved from a deep content classification (DCC) system, the DCC system storing a plurality of concept structures, each concept structure further including a collection of signatures generated based on multimedia data elements.

14. The system of claim 13, wherein the matching at least one concept structure is retrieved from the DCC system based on at least one signature generated for the driving data and the collections of signatures of the plurality of concept structures stored in the DCC system.

15. The system of claim 14, wherein the system is further configured to:
send, to a signature generator system, at least a portion of the driving data, wherein the signature generator system is configured to generate the at least one signature for the driving data based on the sent at least a portion of the driving data.

16. The system of claim 14, wherein the signature generator system includes a plurality of at least statistically independent computational cores, wherein the properties of each core are set independently of the properties of each other core.

17. The system of claim 13, wherein the DCC system is configured to compare the at least one signature generated for the driving data to the collection of signatures of each concept structure, wherein the collection of signatures of each matching concept structure matches the at least one signature generated for the driving data above a predetermined threshold.

18. The system of claim 10, wherein the system is the vehicle control system.
